(19) United States
(12) Patent Application Publication
(10) Pub. No.: US 2020/0290604 A1
(43) Pub. Date: Sep. 17, 2020

(54) METHOD FOR CONTROLLING DRIVING OF AUTONOMOUS VEHICLE

(71) Applicant: SWM CO., LTD., Anyang (KR)

(72) Inventor: Ki Hyuk KIM, Anyang (KR)

(21) Appl. No.: 16/674,795

(22) Filed: Nov. 5, 2019

(30) Foreign Application Priority Data
Mar. 11, 2019 (KR) 10-2019-0027296

(51) Int. Cl. B60W 30/09; B60W 30/095; G05D 1/00; G06K 9/00

(52) U.S. Cl. CPC B60W 30/09; B60W 30/0953; G05D 2201/0213; G06K 9/00825; B60W 2550/408; G05D 1/0088

(57) ABSTRACT

A method for controlling driving of an autonomous vehicle is provided. The method includes recognizing a target vehicle approaching a host vehicle, receiving a d-riving plan of the target vehicle based on absolute coordinates, comparing a driving plan of the host vehicle based on the absolute coordinates with the driving plan of the target vehicle, generating relative coordinates with respect to the host vehicle and the target vehicle, transmitting information about the generated relative coordinates to the target vehicle and requesting the target vehicle to reflect the information about the relative coordinates in the driving plan of the target vehicle to change a driving path of the target vehicle, receiving a signal for approving to reflect the information about the relative coordinates to change the driving plan of the target vehicle, and reflecting the information about the relative coordinates to control driving of the host vehicle.

### CROSS-REFERENCE TO RELATED APPLICATIONS

A claim for priority under 35 U.S.C. § 119 is made to Korean Patent Application No. 10-2019-0027296 filed on Mar. 11, 2019, in the Korean Intellectual Property Office, the entire contents of which are hereby incorporated by reference.

### BACKGROUND

Embodiments of the inventive concept described herein relate to a method for controlling driving of an autonomous vehicle, and more particularly, relate to the method for controlling the driving of the autonomous vehicle to reduce a probability of collision with a target vehicle approaching the autonomous vehicle during driving of the autonomous vehicle such that the autonomous vehicle drives more safely.

Each of general vehicles travels according to driver manipulation such as steering or braking of its driver. An autonomous vehicle travels according to manipulation such as steering or braking without driver intervention. It is predicted that the autonomous vehicle which is surfaced recently as sensor and information communication technologies are developed will become commercialized in the near future.

Meanwhile, before the autonomous vehicle becomes commercialized, the general vehicle driven by its driver is equipped with advanced driver assist devices capable of replacing eyes and ears of the driver for the convenience of the driver. For example, as various sensor, for example, an ultrasonic sensor, an image sensor, a radar sensor, a light detection and ranging (LiDAR) sensor, and the like, are loaded into the vehicle, it has become common in a configuration for warning the driver that there is an object approaching the vehicle during driving or parking of the vehicle or that the vehicle approaches any object. Particularly, recognition determination technologies are applied, for example, lanes displayed on the road may be detected using a camera sensor loaded into the vehicle and a moving object may be detected through the fusion of a camera sensor and a LiDAR sensor.

As such, an autonomous control system capable of controlling driving based on information recognized by various cognitive means loaded into the vehicle is applied to the autonomous vehicle.

Meanwhile, an algorithm capable of suitably coping with various situations which may occur during driving of the vehicle should be applied to the autonomous control system applied to the autonomous vehicle. To this end, research and development capable of coping with many different situations should be performed until complete commercialization of the autonomous vehicle is achieved.

Particularly, research and development sufficient for the probability of collision with a vehicle which approaches from the front of a vehicle which is during autonomous driving.

### PRIOR ART DOCUMENT

### Patent Document

(Patent Document 1) Korean Patent Laid-open Publication No. 10-2019-0000843

(Patent Document 2) Korean Patent No. 10-0904767

(Patent Document 3) Korean Patent Laid-open Publication No. 10-2017-0077332

### SUMMARY

Embodiments of the inventive concept provide a method for controlling driving of an autonomous vehicle to reduce a probability of collision with a target vehicle approaching the autonomous vehicle during driving of the autonomous vehicle such that the autonomous vehicle drives more safely.

According to an exemplary embodiment, a method for controlling driving of an autonomous vehicle may include recognizing a target vehicle approaching a host vehicle, receiving a driving plan of the target vehicle based on absolute coordinates from the target vehicle, comparing a driving plan of the host vehicle based on the absolute coordinates with the driving plan of the target vehicle, generating relative coordinates with respect to the host vehicle and the target vehicle, when it is determined that the host vehicle and the target vehicle are within a collision probability range based on the absolute coordinates, transmitting information about the generated relative coordinates to the target vehicle and requesting the target vehicle to reflect the information about the relative coordinates in the driving plan of the target vehicle to change a driving path of the target vehicle, receiving a signal for approving to reflect the information about the relative coordinates to change the driving plan of the target vehicle from the target vehicle, and reflecting the information about the relative coordinates generated from a relationship with the target vehicle to control driving of the host vehicle.

The reflecting of the information about the relative coordinates may include reflecting the information about the relative coordinates in controlling driving of the host vehicle and driving of the target vehicle, when the host vehicle and the target vehicle are within a predetermined distance range.

The method may further include reducing a driving speed of the host vehicle, when the signal for approving to reflect the information about the relative coordinates to change the driving plan of the target vehicle is not received from the target vehicle.

The method may further include changing a driving path according to the driving plan of the host vehicle based on the absolute coordinates, when the signal for approving to reflect the information about the relative coordinates to change the driving plan of the target vehicle is not received from the target vehicle.

The method may further include driving the host vehicle depending on a changed driving plan of the host vehicle based on the absolute coordinates, when the host vehicle departs from the collision probability range in the relationship with the target vehicle while the host vehicle reflects the information about the relative coordinates in the relationship with the target vehicle to travel.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating a configuration of an autonomous control system for preventing a collision with a target vehicle according to an embodiment of the inventive concept; and

FIG. 2 is a flowchart illustrating a method for controlling driving of an autonomous vehicle according to an embodiment of the inventive concept.

### DETAILED DESCRIPTION

Hereinafter, a description will be given in detail of a method for controlling driving of an autonomous vehicle according to an embodiment of the inventive concept with reference to the accompanying drawings.

The drawings and description are to be regarded as illustrative in nature and not restrictive, and like reference numerals designate like elements throughout the specification. In the entire specification, when an element is referred to as being “connected” to another element, the element may be “directly connected” to the other element with one or more intervening elements interposed in between. Furthermore, unless explicitly described to the contrary, the expression “comprising any element” will be understood to imply the further inclusion of other elements but not the execution of the other elements.

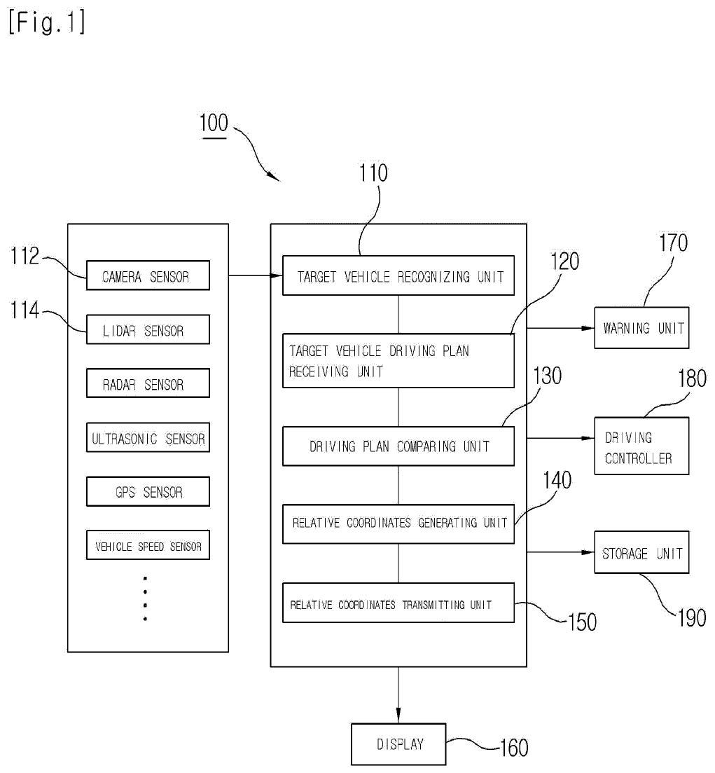

FIG. 1 is a block diagram illustrating a configuration of an autonomous control system for preventing a collision with a target vehicle according to an embodiment of the inventive concept. Reference numeral 100 in FIG. 1 denotes an autonomous control system for preventing a collision with a target vehicle.

As shown in FIG. 1, an autonomous control system 100 for preventing a collision with a target vehicle according to an embodiment of the inventive concept may include a target vehicle recognizing unit 110 for recognizing and specifying a target vehicle approaching a host vehicle (an autonomous vehicle) using a camera sensor 112 or a light detection and ranging (LiDAR) sensor 114 loaded into the host vehicle (the autonomous vehicle), a target vehicle driving plan receiving unit 120 for receiving a driving plan of the target vehicle from the target vehicle specified by the target vehicle recognizing unit 110, a driving plan comparing unit 130 for comparing a driving plan of the host vehicle with the driving plan of the target vehicle, a relative coordinates generating unit 140 for generating relative coordinates with respect to the host vehicle and the target vehicle, and a relative coordinates transmitting unit 150 for transmitting the generated relative coordinates to the target vehicle.

The autonomous control system 100 may further include a display 160 for displaying a relationship with the target vehicle approaching the host vehicle as global positioning system (GPS)-based absolute coordinates or displaying locations of the host vehicle and the target vehicle on the relative coordinates generated on the basis of the locations of the host vehicle and the target vehicle.

Furthermore, the autonomous control system 100 may further include a warning unit 170 for warning a driving controller 180 of the host vehicle to perform braking or deceleration control of the host vehicle, when the autonomous control system 100 requests the target vehicle recognized by the target vehicle recognizing unit 110 to provide a driving plan of the target vehicle and is denied the request, when the autonomous control system 100 requests the target vehicle to reflect the provided relative coordinates to change the driving plan of the target vehicle and is denied the request, or when the autonomous control system 100 should stop reflecting the relative coordinates in control of the host vehicle due to the occurrence of a sudden event while it reflects the relative coordinates to control the host vehicle.

Furthermore, the autonomous control system 100 may further include a storage unit 190 for storing information about driving of the target vehicle, received in a process where the host vehicle is controlled by a method for controlling driving of an autonomous vehicle according to an embodiment of the inventive concept, information about the generated relative coordinates, or data about control information of the host vehicle, in which the relative coordinates are reflected.

The autonomous control system 100 may further include various sensors including a GPS sensor, a radar sensor, an ultrasonic sensor, and a vehicle speed sensor, for recognizing situations of the host vehicle (the autonomous vehicle) and situations around the host vehicle (the autonomous vehicle), other than the camera sensor 112 and the LiDAR sensor 114, which are to be applied to the autonomous vehicle and capture the front of the autonomous vehicle.

The target vehicle recognizing unit 110 of the autonomous control system 100 for preventing the collision with the target vehicle according to an embodiment of the inventive concept may recognize and specify the target vehicle approaching the host vehicle based on information detected by a sensor unit including the camera sensor 112, the LiDAR sensor 114, or the radar sensor, which is loaded into the host vehicle. The target vehicle recognizing unit 110 may be configured to, when there are a plurality of target vehicles approaching the host vehicle, assign a separate identifier to each of the plurality of target vehicles to distinguish each of the plurality of target vehicles and specify the plurality of target vehicles.

In this case, the target vehicle recognized and specified by the target vehicle recognizing unit 110 may be displayed on the display 160 in a specific color. Of course, when there are the plurality of target vehicles, the plurality of target vehicles may be displayed in different colors to distinguish the plurality of target vehicles.

Meanwhile, the autonomous control system 100 should be able to transmit its driving plan to the target vehicle recognized by the target vehicle recognizing unit 110 of the autonomous control system 100 or may receive a driving plane of the target vehicle from the target vehicle, via its communication means. To this end, an autonomous vehicle which travels on the road should include a system capable of sharing its driving plan.

The target vehicle driving plane receiving unit 120 may receive the driving plan of the target vehicle from the target vehicle specified by the target vehicle recognizing unit 110 in the above-mentioned manner. The driving plan of the target vehicle, received from the target vehicle, may include a path on which the target vehicle wants to travel, according to GPS-based absolute coordinates, and a driving speed of the target vehicle.

The driving plan comparing unit 130 of the autonomous control system 100 for preventing the collision with the target vehicle according to an embodiment of the inventive concept may compare the driving plan of the target vehicle, provided from the target vehicle, with the driving plan of the host vehicle to determine whether the host vehicle and the target vehicle are within a collision probability range at a time when they intersect each other. In addition, the driving plan comparing unit 130 may be configured to, when it is predicted that the host vehicle and the target vehicle will be very close to each other (e.g., within 1 m) at a time when they intersect each other depending on the driving plan of the host vehicle and the driving plane of the target vehicle, determine that the host vehicle and the target vehicle are within the collision probability range. The collision probability range may be set to change according to accuracy of the applied GPS absolute coordinates. GPS-based absolute coordinates assigned from a communication satellite have no choice but to have an error of a certain level due to a limit of accuracy the GPS itself has, an error due to occurrence of communication anomaly or the like, or the like.

An embodiment of the inventive concept may more accurately control the autonomous vehicle by generating and reflecting relative coordinates with respect to the host vehicle and the target vehicle in control of the autonomous vehicle by the GPS-based absolute coordinates if necessary, thus preventing a safety accident.

To this end, when it is determined that the host vehicle and the target vehicle are within the collision probability range as a result of comparing the driving plan of the host vehicle with the driving plan of the target vehicle approaching the host vehicle, the relative coordinates generating unit 140 may generate relative coordinates with respect to the host vehicle and the target vehicle. The relative coordinates may include information about a relative distance and direction according to a driving speed of the host vehicle and a driving speed of the target vehicle.

Particularly, appearance information (including length, width, and height information) of the host vehicle and appearance information (including length, width, and height information) of the target vehicle as well as a reference point which is the center of the relative coordinates of the host vehicle and the target vehicle may be included in information about the relative coordinates. In this case, the appearance information of the host vehicle or the target vehicle may be based on specifications of the host vehicle or the target vehicle when the host vehicle or the target vehicle is released. Furthermore, when the appearance of the vehicle is transformed, an update on the appearance of the vehicle may include a configuration to which updated information is applicable.

In addition, each vehicle may be equipped with a three-dimensional (3D) scan means capable of three-dimensionally scanning the appearance of the target vehicle. For example, as a payload such as skis or a bicycle is mounted on a loop of the vehicle or as a payload such as a bicycle is mounted on the rear of the vehicle, when the predetermined appearance of the vehicle is changed, the changed appearance should be reflected in information about relative coordinates.

The relative coordinates transmitting unit 150 of the autonomous control system 100 for preventing the collision with the target vehicle according to an embodiment of the inventive concept may transmit information about the generated relative coordinates to the target vehicle. In this case, the host vehicle may be configured to request the target vehicle whether to approve to reflect the information about the shared relative coordinates in a driving control process of the target vehicle to change the driving plan of the target vehicle.

When receiving a signal for approving to reflect the information about the relative coordinates, provided from the target vehicle, to change the driving plan of the target vehicle, the host vehicle may be configured to reflect the information about the relative coordinates generated in a relationship with the target vehicle in the driving plan of the host vehicle to perform vehicle control.

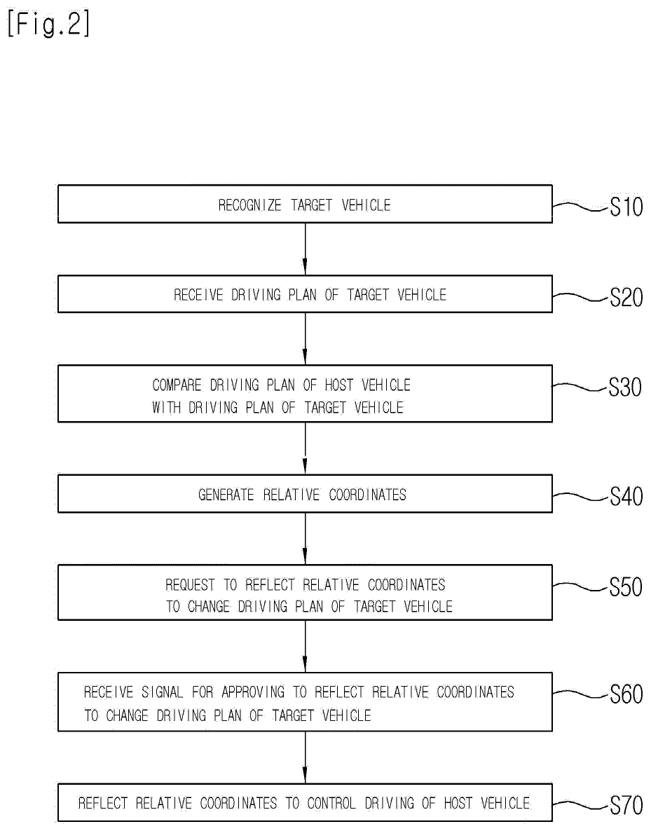

FIG. 2 is a flowchart illustrating a method for controlling driving of an autonomous vehicle according to an embodiment of the inventive concept.

As shown in FIG. 2, the method for controlling the driving of the autonomous vehicle according to an embodiment of the inventive concept may include recognizing a target vehicle (S10), receiving a driving plan of the target vehicle (S20), comparing a driving plan of a host vehicle with the driving plan of the target vehicle (S30), generating relative coordinates (S40), requesting to reflect the relative coordinates to change the driving plan of the target vehicle (S50), receiving a signal for approving to reflect the relative coordinates to change the driving plan of the target vehicle (S60), and reflecting the relative coordinates to perform driving control (S70).

A description will be given of a process where an autonomous vehicle performs driving control using the method for controlling the driving of the autonomous vehicle according to an embodiment of the inventive concept.

In S10, a target vehicle recognizing unit 110 of FIG. 1 may recognize and specify the target vehicle approaching the host vehicle based on information detected by various sensors including a camera sensor 112, a LiDAR sensor 114, a GPS sensor, a radar sensor, an ultrasonic sensor, and a vehicle speed sensor, which are loaded into the host vehicle.

In S20, a target vehicle driving plan receiving unit 120 of FIG. 1 may receive an expected driving path according to a driving plan of the target vehicle based on GPS absolute coordinates from the target vehicle approaching the host vehicle. In S30, a driving plan comparing unit 130 of FIG. 1 may compare an expected driving path according to a driving plan of the host vehicle based on the GPS absolute coordinates with the expected driving path according to the driving plan of the target vehicle.

When it is expected that the host vehicle and the target vehicle will be within a collision probability range at a specific time in S30, in S40, a relative coordinates generating unit 140 of FIG. 1 may generate relative coordinates with respect to the host vehicle and the target vehicle. In this case, the generated relative coordinates may include information about a location, distance, speed, or direction of the host vehicle and information about a location, distance, speed, or direction of the target vehicle.

In S50, a relative coordinates transmitting unit 150 of FIG. 1 may transmit the information about the generated relative coordinates to the target vehicle and may request the target vehicle to reply whether to approve to reflect the information about the relative coordinates to change the driving plan of the target vehicle.

When receiving a signal for approving to reflect the information about the relative coordinates, provided from the target vehicle, to change the driving path of the target vehicle in S60, in S70, the host vehicle may reflect the information about the relative coordinates to change its driving path.

Through such a process, a distance from the target vehicle approaching the host vehicle may be more safely maintained to prevent a collision between autonomous vehicles.

The host vehicle may be configured to, when the host vehicle departs from a collision probability range in a relationship with the target vehicle after the host vehicle and the target vehicle intersect each other without collision, travel according to the changed driving plan of the host vehicle based on the absolute coordinates.

Meanwhile, the host vehicle may be configured to, when an approaching distance of the target vehicle is less than a predetermined distance in a state where the host vehicle does not receive the signal for approving to reflect the information about the relative coordinates to change the driving plan of the target vehicle from the target vehicle, reduce its driving speed to prevent a safety accident.

Furthermore, the host vehicle may be configured to, when an approaching distance of the target vehicle is less than the predetermined distance in the state where the host vehicle does not receive the signal for approving to reflect the information about the relative coordinates to change the driving plan of the target vehicle from the target vehicle, change its driving path according to the driving plan based on the absolute coordinates, such that the host vehicle and the target vehicle may intersect each other outside the collision probability range.

As described above, the description is given of the method for controlling the driving of the autonomous vehicle according to an embodiment of the inventive concept with reference to the accompanying drawings.

The above-mentioned technical contents may be implemented in the form of program instructions executable through various computer means to be recorded in computer-readable media. The computer-readable media may include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like.

Program instructions include both machine code, such as produced by a compiler, and higher-level language code that may be executed by the computer using an interpreter. The hardware devices may be configured to act as one or more software modules to perform the operations of the above-described exemplary embodiments of the inventive concept, or vice versa.

According to embodiments of the inventive concept, the method for controlling the driving of the autonomous vehicle may effectively prevent a collision between autonomous vehicles when there is an autonomous vehicle approaching a host vehicle (an autonomous vehicle) during driving of the host vehicle (the autonomous vehicle).

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for controlling driving of an autonomous vehicle, the method comprising:
recognizing a target vehicle approaching a host vehicle;
receiving a driving plan of the target vehicle based on absolute coordinates from the target vehicle;
comparing a driving plan of the host vehicle based on the absolute coordinates with the driving plan of the target vehicle;
generating relative coordinates with respect to the host vehicle and the target vehicle, when it is determined that the host vehicle and the target vehicle are within a collision probability range based on the absolute coordinates;
transmitting information about the generated relative coordinates to the target vehicle and requesting the target vehicle to reflect the information about the relative coordinates in the driving plan of the target vehicle to change a driving path of the target vehicle;
receiving a signal for approving to reflect the information about the relative coordinates to change the driving plan of the target vehicle from the target vehicle; and
reflecting the information about the relative coordinates generated from a relationship with the target vehicle to control driving of the host vehicle.

2. The method of claim 1, wherein the reflecting of the information about the relative coordinates includes:
reflecting the information about the relative coordinates in controlling driving of the host vehicle and driving of the target vehicle, when the host vehicle and the target vehicle are within a predetermined distance range.

3. The method of claim 1, further comprising:
reducing a driving speed of the host vehicle, when the signal for approving to reflect the information about the relative coordinates to change the driving plan of the target vehicle is not received from the target vehicle.

4. The method of claim 1, further comprising:
changing a driving path according to the driving plan of the host vehicle based on the absolute coordinates, when the signal for approving to reflect the information about the relative coordinates to change the driving plan of the target vehicle is not received from the target vehicle.

5. The method of claim 1, further comprising:
driving the host vehicle depending on a changed driving plan of the host vehicle based on the absolute coordinates, when the host vehicle departs from the collision probability range in the relationship with the target vehicle while the host vehicle reflects the information about the relative coordinates in the relationship with the target vehicle to travel.
